(19) United States
(12) Patent Application Publication
(10) Pub. No.: US 2026/0244460 A1
(43) Pub. Date: Aug. 20, 2026

(54) GENERATING AN INTERFACE OF CONTENT ITEMS

(71) Applicant: Walmart Apollo, LLC, Bentonville, AR (US)

(72) Inventors: Soumojit Guha Majumder, Bangalore (IN); Chittaranjan Tripathy, Sunnyvale, CA (US); Sujit Shambuling Horakeri, Hubli (IN); Shubhodeep Moitra, Bangalore (IN); Subhasish Misra, Bangalore (IN); Harshal Tripathi, Sunnyvale, CA (US); Swati Kirti, Bellevue, WA (US); Somedip Karmakar, Bangalore (IN)

(21) Appl. No.: 19/057,083

(22) Filed: Feb. 19, 2025

(51) Int. Cl. G06F 9/451; G06F 16/9535; G06F 16/9538

(52) U.S. Cl. CPC G06F 9/451; G06F 16/9535; G06F 16/9538

(57) ABSTRACT

Example implementations relate to content item selection in a network environment. In an example, a plurality of user features is received and at least one characteristic of a plurality of content items having at least a first value is obtained. Using a causal inference framework and based on the plurality of user features, an expected increase in user interaction with the plurality of content items between the at least one characteristic of the plurality of content items having the first value and the at least one characteristic of the plurality of content items having a second value is calculated. Using the expected increase in user interaction with the plurality of content items, a recommended value for the at least one characteristic of the plurality of content items is calculated and an interface including the plurality of content items having the recommended value for the at least one characteristic is generated.

### TECHNICAL FIELD

This application relates generally to automated content item selection, and more particularly, to automated content item selection in network environments.

### BACKGROUND

Some network systems, such as social media, fitness, news, logistics, delivery and/or e-commerce network systems, generate interfaces that include selected or recommended content items. These systems may select content items for inclusion in interfaces based on various parameters. Generated interfaces may be provided to user devices to enable user interactions with the network system.

### BRIEF DESCRIPTION OF THE DRAWINGS

Various examples will be described below with reference to the following figures.

FIG. 1 is a block diagram of an example item display selection system in accordance with some embodiments.

FIG. 2 is a block diagram of an example item display selection system within a network environment in accordance with some embodiments.

FIG. 3 is a block diagram of an example item display selection system in accordance with some embodiments.

FIG. 4 is a block diagram of an example item display selection system within a network environment in accordance with some embodiments.

FIG. 5 is a schematic diagram of an example causal inference framework in accordance with some embodiments.

FIG. 6 is a schematic diagram of an example reinforcement learning optimizer in accordance with some embodiments.

FIG. 7 is an example distribution of a reward function in accordance with some embodiments.

FIG. 8 is a flowchart illustrating an example item display selection method in accordance with some embodiments.

FIG. 9 is a flowchart illustrating an example causal inference method in accordance with some embodiments.

FIG. 10 is a flowchart illustrating an example reinforcement learning optimization method in accordance with some embodiments.

FIG. 11 is an example machine-readable storage medium in accordance with some embodiments.

FIG. 12 depicts a block diagram of an example item display optimization computing device in accordance with some embodiments.

### DETAILED DESCRIPTION

The disclosed systems and methods provide a content item selection process that finds a recommended value for a characteristic of content items to facilitate user interaction with the content items on a network environment. For example, the characteristic may be the number of content items that is presented to a user. Content item selection may also be referred to hereinafter as item display selection or item display optimization. The display region for providing content items, such as recommendations, via an application user interface associated with a network environment to a user may be limited, and identifying an appropriate number of content items that may best increase (e.g., maximize) user interaction (e.g., viewing of content items, purchase, and/or lease of an item associated with a content item) may enhance operations in the network environment and/or improve user experience. The network environment may include a platform on which users may disclose and/or receive information (e.g., fitness, news, logistics, delivery, or other types of information), interact via social media, list services for sale (e.g., house cleaning, plumbing, vehicle rental or repair, grocery and food services, etc.), list items for sale, and/or buy items offered by sellers. For example, a user may see a recommended number K of content items before the user has a higher likelihood of locating an item for further viewing and/or purchase.

The methods and systems described herein may provide a causal estimate to identify a recommended value K for one or more characteristics of the content items. Optionally, the process for calculating the recommended value of K may be automated, and may include capabilities such as monitoring and/or logging the recommended value of K (e.g., an optimized value of K) as a function of time. In some embodiments, the methods and systems described herein may be implemented and/or built with minimal human intervention, which may minimize errors, biases and/or cost. In some embodiments, the methods and systems described herein may utilize observational data (e.g., calculating a lift by making causal inferences, as described below) in a manner that minimizes interruption or hindrance to various processes on the network environment.

Recommendation carousels in a network environment may showcase item variety available in the network environment and encourage user exploration of items available in the network environment. Displaying only a fixed number of content items in a recommendation carousel (e.g., without taking into account any context) may lead to a suboptimal utilization of valuable display real estate in an application user interface associated with the network environment, and may reduce the carousel's effectiveness and adaptability across diverse item categories, user devices, and browsing contexts. Similarly, opportunities for personalization and dynamic content presentation (e.g., real-time interaction context such as browsing or purchasing context) may be restricted when a fixed number of content items, and/or a fixed display size of content items are displayed. In some embodiments, as described herein, a more dynamic approach that adjusts the number of content items displayed, based on factors such as screen size of the device, a complexity of the category of item (e.g., groceries versus electronic products), a user's current browsing session and historical user behavior may significantly enhance user engagement rates (e.g., rates of viewing content items, rates of purchasing and/or leasing items associated with the content items). By optimizing the number of displayed content items, a display size of the content items, and/or other characteristics of the content items, a recommendation carousel may evolve from a static display into a more dynamic, responsive, and personalized component of the network environment, maximizing its potential to drive item discovery and increase various transactions in the network environment. The methods and systems described herein calculate recommended values for one or more characteristics of the content items, such as a number of the content items (e.g., a carousel length) and/or a display size of the content items, optionally in addition to accounting for various aspects of personalization and optimization.

For example, the methods and systems described herein may be distinguished from rule-based or heuristic approaches, which may fail to capture and learn from the nuances of individual user behavior and diverse browsing contexts, resulting in a generic and potentially suboptimal presentation. While useful for comparing different carousel configurations, A/B testing may provide only limited insights into the causal impact of the number of displayed content items on user engagement. Furthermore, setting up and managing A/B tests for numerous carousel variations may be complex and resource intensive. Collaborative or content-based filtering may focus primarily on recommending relevant content items within a recommendation carousel, rather than optimizing the number of content items, or the size of content items displayed, such that the issue of information overload or the efficient use of screen real estate may not be addressed. For example, while effective for exploring different options and exploiting the best-performing ones, bandit algorithms may not capture long-term effects of carousel length, which itself may be a causal outcome (e.g., lift/incrementality in one or more key business metrics), on user behavior, and may also be sensitive to noise in user interactions, leading to potentially unstable results.

A static, one-size-fits-all approach to carousel presentation may lead to user frustration and disengagement, particularly on smaller screens or when browsing complex product categories. Ineffective carousels may hinder product discovery and impact an amount or volume of transactions in the network environment. In some embodiments, the methods and systems described herein may facilitate presentation of an optimal number of items that may help to capture interest and prompt transactions on the network environment. A dynamic approach to better utilize a display and/or recommendation space more effectively may enable more relevant information to be presented to a user in a more concise and engaging manner.

In various embodiments, a system including a processor and a non-transitory memory storing instructions is disclosed. The instructions, when executed, cause the processor to receive a plurality of user features and obtain at least one characteristic of a plurality of content items having at least a first value and a second value that is different from the first value. The instructions further cause the processor to calculate, using a causal inference framework and based on the plurality of user features, an expected increase in user interaction with the plurality of content items between the at least one characteristic of the plurality of content items having the first value and the at least one characteristic of the plurality of content items having the second value. The instructions further cause the processor to calculate, using the expected increase in user interaction with the plurality of content items, a recommended value for the at least one characteristic of the plurality of content items that facilitates user interaction with the plurality of content items. The instructions further cause the processor to generate an interface that includes the plurality of content items having the recommended value for the at least one characteristic.

In various embodiments, a computer-implemented method is disclosed. The computer-implemented method includes steps of receiving a plurality of characteristics associated with one or more users and obtaining at least one characteristic of a plurality of content items having at least a first value and a second value that is different from the first value. The computer-implemented method further includes a step of calculating, using a causal inference framework and based on the plurality of characteristics associated with the one or more users, an expected increase in user interaction with the plurality of content items between the at least one characteristic of the plurality of content items having the first value and the at least one characteristic of the plurality of content items having the second value. The computer-implemented method further includes a step of calculating, using the expected increase in user interaction with the plurality of content items, a recommended value for the at least one characteristic of the plurality of content items that facilitates user interaction with the plurality of content items. The computer-implemented method further includes a step of generating an interface that includes the plurality of content items having the recommended value for the at least one characteristic.

In various embodiments, a non-transitory computer-readable medium having instructions stored thereon is disclosed. The instructions, when executed by at least one processor, cause at least one device to perform operations including receiving a plurality of characteristics associated with one or more users and obtaining at least one characteristic of a plurality of content items having at least a first value and a second value that is different from the first value. The instructions further cause the at least one device to perform operations including calculating, using a causal inference framework based on the plurality of characteristics associated with the one or more users, an expected increase in user interaction with the plurality of content items between the at least one characteristic of the plurality of content items having the first value and the at least one characteristic of the plurality of content items having the second value. The instructions further cause the at least one device to perform operations including calculating, using the expected increase in user interaction with the plurality of content items, a recommended value for the at least one characteristic of the plurality of content items that facilitates user interaction with the plurality of content items and generating an interface that includes the plurality of content items having the recommended value for the at least one characteristic.

This description of the example embodiments is intended to be read in connection with the accompanying drawings that are to be considered part of the entire written description. Terms concerning data connections, coupling and the like, such as “connected,” “interconnected,” and/or “in signal communication with” refer to a relationship wherein systems or elements are electrically connected (e.g., wired, wireless) to one another, either directly or indirectly, through intervening systems, unless expressly described otherwise. The term “operatively coupled” is such a coupling or connection that enables the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

Furthermore, in the following, various embodiments are described with respect to methods and systems for content item selection. The ability to compute a casual effect indicative of changes in probabilities of interaction between the user and a content item associated with an underlying item may enable the content item selection system to be responsive to the unique preferences and/or behavior of the user by delivering individualized recommendations to the user (e.g., by presenting one or more content items associated with the one or more items listed on the network environment to the user), improving the relevance of displayed content items and increasing user interactions with the content items (e.g., recommendations, and/or other information) provided by the network environment to the user, and may help improve user experience and/or increase the ease of performing various interactions (e.g., transactions, and/or other operations) in the network environment. A content item selection system, as described herein in some embodiments, may function as a recommendation system for selecting content items, which correspond to items listed in the network environment, that would be presented to a user.

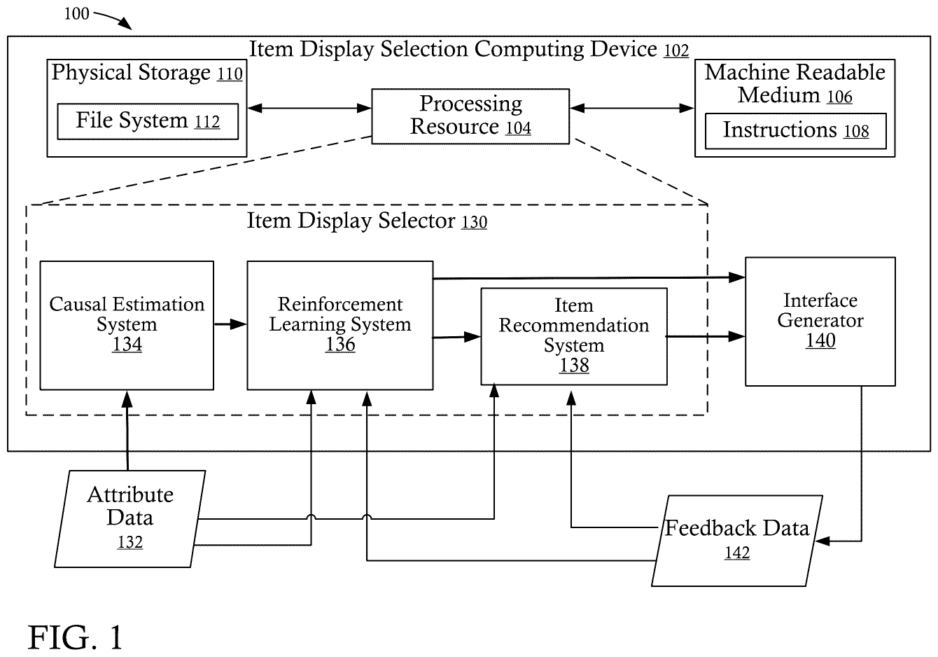

FIG. 1 depicts an example system 100 that implements item display selection, in accordance with some embodiments. System 100 includes an item display selection computing device 102 that selects a value for at least one characteristic of content items to be displayed to a user. The item display selection computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The item display selection computing device 102 includes a non-transitory machine-readable medium 106 that may include one or more of a random-access memory (RAM), read-only memory (ROM), electrically erasable programmable read-only memory (EEPROM), flash memory, hard disk, and/or any other suitable memory resource.

In some embodiments, the item display selection computing device 102 selects a value for at least one characteristic of content items to be presented (e.g., displayed on a user interface) to a user. For example, the user may not be aware of an item in the network environment that may be relevant (e.g., highly relevant) to the user, and the item display selection computing device 102 identifies and presents one or more such content items to the user. The processing resource 104 may execute instructions 108 (i.e., programming or software code) stored on machine readable medium 106 to perform functions of the item display selection computing device 102, such as receiving a plurality of user features (e.g., via attribute data 132) and obtaining at least one characteristic of a plurality of content items having at least a first value and a second value that is different from the first value. For example, the at least one characteristic may include a number of content items to be displayed to the user, and/or display sizes of the content items. For example, the first value may be five content items, while the second value may be two content items. The attribute data 132, which may be derived from data records include network activities of a user, attributes associated with user interactions with one or more content items (e.g., previous recommendations), and/or information related to the user, are processed and provided as input data to the item display selector 130. For example, the item display selection computing device 102 receives a plurality of user features (e.g., via the attribute data 132) and provides input data that is derived from the plurality of user features to an item display selector 130.

The instructions 108 may include instructions for calculating, using a causal inference framework (e.g., a causal estimation system 134, as described in detail below), and based on the plurality of user features (e.g., obtained through attribute data 132), an expected increase in user interaction with the plurality of content items between the at least one characteristic of the plurality of content items having the first value and the at least one characteristic of the plurality of content items having the second value. The instructions 108 may include instructions for calculating, using the expected increase in user interaction with the plurality of content items (e.g., calculated by the causal estimation system 134, as described in detail below), a recommended value for the at least one characteristic of the plurality of content items that facilitates user interaction with the plurality of content items (e.g., calculated by a reinforcement learning system 136, as described in detail below). The instructions 108 may include instructions for implementing one or more models. In some embodiments, and as will be described further herein below, the item display selection computing device 102 may execute one or more models, processes, or algorithms, such as a machine learning model, deep learning model, statistical model, etc., (e.g., implemented as machine readable instructions), to select a value for at least one characteristic of content items to be displayed.

The item display selection computing device 102 may also include other hardware components, such as physical storage 110. Physical storage 110 may include any physical storage device, such as a hard disk drive, a solid-state drive, or the like, or a plurality of such storage devices (e.g., an array of disks), and may be locally attached (e.g., installed) in the item display selection computing device 102. In some implementations, physical storage 110 may be accessed as a block storage device.

In some cases, the item display selection computing device 102 may also include a local file system 112 that may be implemented as a layer on top of the physical storage 110. For example, an operating system may be executing on the item display selection computing device 102 (by virtue of the processing resource 104 executing certain instructions 108 related to the operating system) and the operating system may provide a file system 112 to store data on the physical storage 110.

The item display selection computing device 102 may be in communication with one or more additional devices over one or more network channels. For example, in various embodiments, the item display selection computing device 102 may be in communication with a web server, a cloud-based engine including one or more processing devices that may be provisioned for use, a database, a workstation, and/or any other suitable system or device. The item display selection computing device 102 may similarly be in communication, either directly or indirectly, with one or more user computing devices operatively coupled over the network. The other computing systems may be similar to the item display selection computing device 102 and may each include at least a processing resource and a machine-readable medium.

In some embodiments, the item display selection computing device 102, such as the processing resource 104, includes an item display selector 130 that also implements an item recommendation system 138. In some embodiments, the item recommendation system 138 may generate personalized recommendations to a user based on, for example, the attribute data 132, additional information derived from the network environment, feedback data 142 generated, for example, from user interaction and/or output from the reinforcement learning system 136. In some embodiments, the reinforcement learning system 136 may also receive attribute data 132. In some embodiments, the feedback data 142 may be used to refine the item recommendation system 138 and/or the reinforcement learning system 136. In some embodiments, the item recommendation system 138 may adopt a two-pronged approach, first by processing items (e.g., items listed on the network environment, items listed for sale or lease on the network environment) based on content similarity between the content items to identify, for example, items that are semantically similar or complementary. In some embodiments, the items may be compared based on their respective textual description using embeddings, such as Bidirectional Encoder Representations from Transformers (BERT), and/or using cosine similarity. In some embodiments, both textual information and visual information (item figures, videos) may be used to generate the embeddings which are then compared for similarity and/or complementarity. In some embodiments, the second prong of the item recommendation system 138 may include feedback-driven re-ranking of the list of items to be recommended, for example, by using user interactions with the content items to train a ranking model (e.g., provided as feedback data 142). In some embodiments, the feedback data 142 may include user interactions with content items associated with one or more items listed in the network environment (e.g., recommendations for one or more items). The user interactions may include one or more of: a user clicking on content items associated one or more items listed on the network environment, a user adding the items associated with the content items to a cart, a user dismissing one or more content items, and/or a user forwarding the items associated with the content items to another user.

In some embodiments, the ranking model in the item recommendation system 138 re-ranks an initial similarity list generated by the first prong of the item recommendation system 138, and the ranking model may prioritize items that have a higher chance of user interaction and/or user engagement. In some embodiments, the item recommendation system 138 combines both the results from the approach of the first prong (e.g., based on similarity of the items listed on the network environment) and results from the approach of the second prong (e.g., based on user feedback) to provide final recommendations that are personalized and/or data-driven. For example, the item recommendation system 138 includes a trainer for a ranking model that is based on user interactions with the plurality of content items. The ranking model may generate a ranked listing of the plurality of content items based on a likelihood of user interaction with the plurality of content items. In some embodiments, output from the item display selector 130 (e.g., from the item recommendation system 138 and/or the reinforcement learning system 136) is provided to an interface generator 140 to generate an application user interface that includes content items having a recommended value for at least one characteristic of the content items (e.g., a number of content items, and/or a display size of the content items).

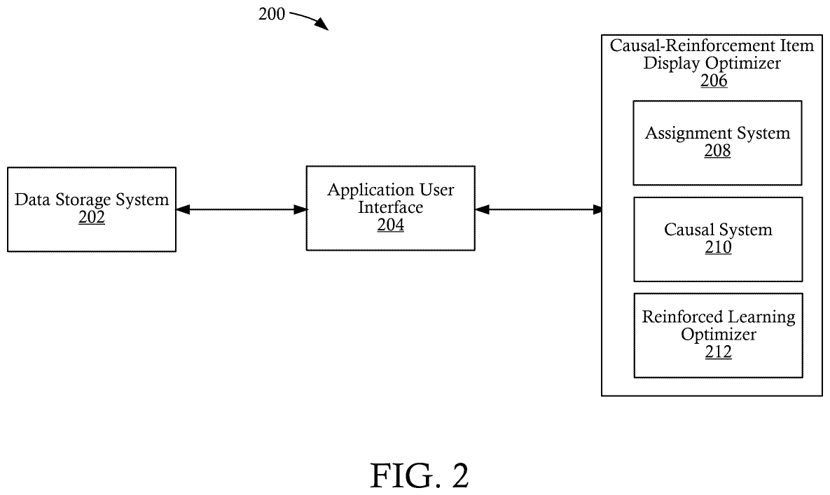

FIG. 2 is a schematic diagram of the different components of an example content item selection system 200 in accordance with some embodiments. The content item selection system 200 may be implemented by a computing device, such as the item display selection computing device 102 illustrated in FIG. 1. In some embodiments, the content item selection system 200 selects a recommended value for one or more characteristics of content items that are presented to a user via an application user interface 204. The content item selection system 200 implements a content item selection process that selects one or more recommended value associated with one or more characteristics of a plurality of content items that are presented to a user based on a determined likelihood that the recommended value would facilitate user interaction with content items having a characteristic of the recommended value.

In some embodiments, the content item selection system 200 includes a data storage system 202. In some embodiments, the data storage system 202 may store information that generates the attribute data 132. For example, the data storage system 202 may include a database that stores transaction data. The transaction data may include transaction sources (e.g., web orders, in-store orders, etc.), transactions associated with a predetermined period (such as in the last three months, or another time duration), transactions including predetermined items and/or predetermined categories, total expenses associated with a transaction, average expenses for all transactions, a transaction interval, a transaction regularity, and/or any other transactional features. Transactional data can include historical data (e.g., data representative of prior transactional interactions with one or more systems associated with a particular retailer or service provider) and/or real-time data (e.g., data representative of a current interaction with one or more systems associated with a particular service provider).

In some embodiments, the data storage system 202 may include a database that stores demographic data of one or more users. The demographic data may include one or more of: a user identifier, age, gender, occupation, income, vehicle ownership status, education level, and/or other information related to an individual associated with the user identifier. For example, the user identifier may contain a unique data representation associated with a user. Demographic features can be obtained from the user, for example during interactions with a user interface, and/or can be obtained from a third-party data provider. In some embodiments, demographic information is partially anonymized prior to being associated with a user profile. For example, in some embodiments, demographic features can be converted into bands or buckets that associate a user identifier with a particular segment of a population (e.g., individuals aged 18-35, individuals within a particular zip code) without providing exact identifying information for a particular user (e.g., without providing an exact age). The demographic data may include customer segment classifications, and/or any other suitable model-specific features. In some embodiments, a user identifier may be segmented into multiple customer segment classifications based on historical interaction data and/or user preference selections. In some embodiments, the demographic features may indicate the user's preferences for different interactions or user engagement (e.g., automobile-related transactions to purchase related products, and/or grocery-related transactions).

In some embodiments, the data storage system 202 may include a database that stores historical interaction information about content items that have been viewed by one or more users on the network environment, and/or how the one or more user engage with the content items provided by the network environment (e.g., which content items were clicked by the one or more users, which content items were closed by the one or more users, and/or what further interactions occurred upon the one or more users clicking on the content item). In some embodiments, the data storage system 202 may include a database that stores information about items associated with the network environment. For example, the items may include items that are listed (e.g., for sale, for viewing, and/or other interactions) on the network environment (e.g., in a catalog or other data systems).

The content item selection system 200 includes an application user interface 204 (e.g., communicatively coupled to the application user interface 204) via which the content item selection system 200 may interact with one or more users of the network environment. For example, the application user interface 204 may include an interface of a website associated with the network environment. The website may enable one or more users of the network environment to view, select, and place orders on one or more items listed in the network environment (e.g., listed for sale, listed for lease, and/or other transactions, such as items listed in one of the databases of the data storage system 202), and the website may include functionalities to process one or more transactions (e.g., monetary transactions or other transactions). The application user interface 204 may also present one or more content items to a user (e.g., in a recommendation carousel). The content items may be associated with one or more items listed in databases of the data storage system 202. At least one characteristic of the content items displayed on the application user interface 204 may have a value (e.g., a recommended value) that is selected by a causal-reinforcement item display optimizer 206 (e.g., implemented as the item display selector 130).

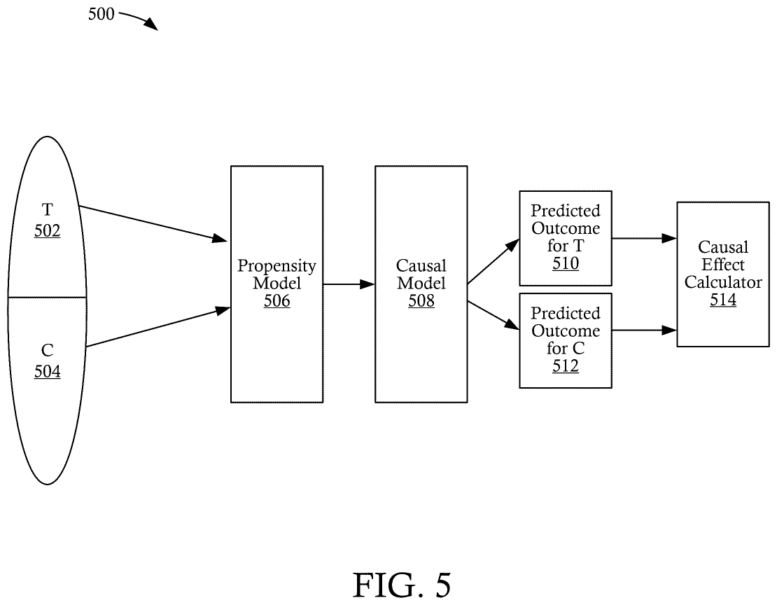

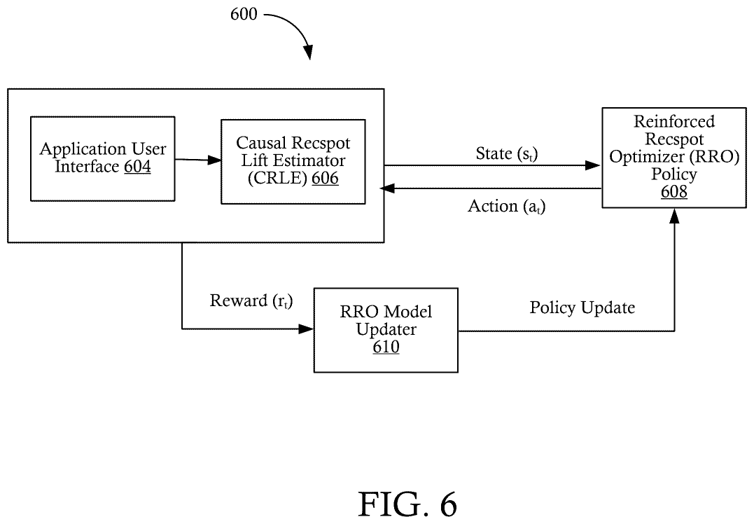

The causal-reinforcement item display optimizer 206 includes a causal system 210, a reinforced learning optimizer 212, and an assignment system 208. The causal system 210, described in greater detail below with reference to FIG. 5, evaluates an expected increase in user interaction caused by a change in a value of at least one characteristic of the content items. In some embodiments, the causal system 210 may be implemented by the item display selector 130 (e.g., by the causal estimation system 134) illustrated in FIG. 1. In some embodiments, the expected increase in user interaction may also referred to as an expected lift, a lift value, causal effect, treatment effect, impact, and/or incrementality. The expected increase determined by the causal system 210 is provided to the reinforced learning optimizer 212, described in greater detail below with reference to FIG. 6, to calculate a recommended value for the at least one characteristic of the content items to be presented to a user via the application user interface 204. In some embodiments, the reinforced learning optimizer 212 may be implemented by the item display selector 130 (e.g., by the reinforcement learning system 136) illustrated in FIG. 1. In some embodiments, the assignment system 208 may receive the output from the reinforced learning optimizer 212 and/or the causal system 210, and may provide an assignment of a recommended value of the at least one characteristic of the content items to the application user interface 204.

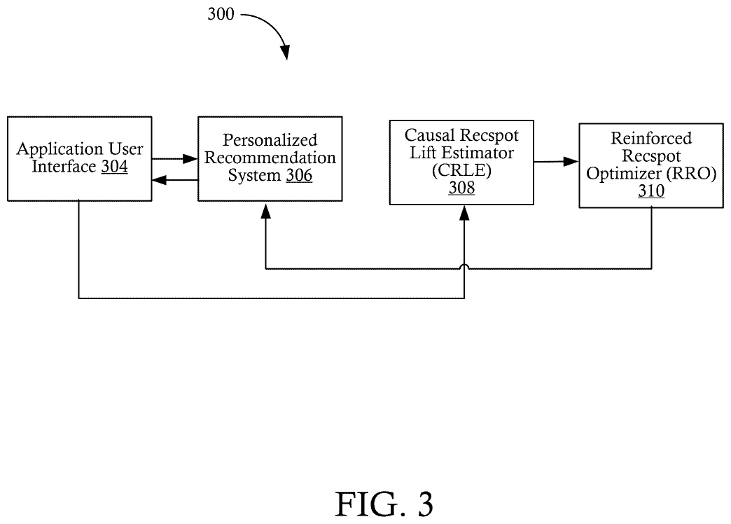

FIG. 3 is a block diagram of an example item display optimizer 300 in accordance with some embodiments. The item display optimizer 300 may be implemented by a computing device, such as the item display selection computing device 102 illustrated in FIG. 1. In some embodiments, the item display optimizer 300 selects a recommended value for one or more characteristics of content items that are presented to a user via an application user interface 304. The recommended value may sometimes be referred to as a “recspot.” In some embodiments, the recspot may correspond to a quantity of content items that are displayed to a user. In some embodiments, the recspot may correspond to a display size of the content items presented to a user. The item display optimizer 300 includes an application user interface 304 (e.g., generated by an interface generator analogous to the interface generator 140 in FIG. 1, or by an interface generator communicatively coupled to the item display optimizer 300), a personalized recommendation system 306, a causal recspot lift estimator (CRLE) 308, and a reinforced recspot optimizer (RRO) 310.

In some embodiments, the CRLE 308 calculates an expected increase in user interaction and provides the output to the RRO 310, which calculates a recommended value N for a characteristic of the content items. The recommended value N is provided to a personalized recommendation system 306 to select content items matching the recommended value N for displaying on the application user interface 304. For example, top N number of content items may be provided by the personalized recommendation system 306 to be displayed on the application user interface 304. User interaction within the application user interface 304 (e.g., clicking on, opening, closing and/or disregarding one or more of the top N number of content items) may provide feedback information to the personalized recommendation system 306 (e.g., to fine-tune subsequent recommendations) and/or the CRLE 308 as input data for calculating the expected increase in user interaction caused by the display of the N number of content items.

The CRLE 308 may use the following example process to determine the expected increase in user interaction. The example process may involve different i number of iterations, each iteration may involve a specific value of K, defined as a variable associated with a characteristic of the content items to be assessed. For example, K may correspond to a number of recspots, or a display size associated with each recspot. For a given iteration i, a value of K is defined and content items having the characteristic of the value of K are allocated to selected users. For example, the selected users may be presented with an application user interface displaying K number of content items. The selected users may also sometimes be referred to as being in a treated group or a treatment group. All other users not allocated the content items having the characteristic of the value of K are used to determine the counterfactual and/or are considered to be in the control group. For example, users in the control group may be presented with an application user interface having fewer than K number of content items.

In some embodiments, a feature vector is generated for each treated user and at least a subset of the control group (e.g., a majority of the control group, and/or all of the control group). In some embodiments, the feature-vector for a particular user is generated based on one or more of: a recency of transactions by the user on the network environment (e.g., a quantity, a value, and a number of visits in the network environment), a time duration of each visit or session in the network environment, and/or user profile information, such as an age of an account of the user on the network environment. In some embodiments, the CRLE 308 may include a counterfactual estimator that calculates the expected increase in user interaction. The counterfactual estimator may match, based on propensity scores, (i) a selected user presented with the plurality of content items having the at least one characteristic of the first value to (ii) a control user presented with the plurality of content items having the at least one characteristic of a value different from the first value.

In some embodiments, for the given iteration i, each user Tₙ in the treated group is matched to a user Cₙ in the control group based on their respective propensity scores (e.g., the matched user Cₙ having a closest propensity score to the user Tₙ, or based on another criterion with respect to the propensity score). The matched user Cₙ in the control group may sometimes be referred to as the counterfactual of the user Tₙ. In some embodiments, for a control user Cₙ, a counterfactual may also be found from the treatment group.

In some embodiments, based on the pairing of the matched user Cₙ in the control group with the user Tₙ in the treated group, a counterfactual estimate may be calculated based on the respective potential outcomes of the user Tₙ in the treated group being presented with the K number of content items, or another value for another characteristic of the content items and the user Cₙ in the control group being presented with a number of content items different from the K number of content items, or another value for another characteristic of the content item. For example, for each observation unit c, which may correspond to a user Tₙ in the treated group, or a user Cₙ in the control group, the potential outcome Y may be Y_{c}(T=1) when the observation unit c is provided with treatment (e.g., being presented with K number of content items, or another value for another characteristic of the content items) or Y_{c}(T=0) when the observation unit c is not provided with treatment (e.g., being presented with a number of content items different from K, or another value for another characteristic of the content items). For example:

$${Y}_{c} = {Y}_{c} ( {T}_{c} ) = \{ \begin{matrix}{Y}_{c} ( 0 ) if {T}_{c} = 0 , \\ {Y}_{c} ( 1 ) if {T}_{c} = 1\end{matrix} = {T}_{c} {Y}_{c} ( 1 ) + ( 1 - {T}_{c} ) {Y}_{c} ( 0 )$$

In some embodiments, counterfactual reasoning includes computing a unit/user level treatment effect τ_{c}, which corresponds to the difference in potential outcome with treatment Y_{c}(T_{c}=1) and potential outcome without treatment Y_{c}(T_{c}=0): τ_{c}=Y_{c}(1)−Y_{c}(0). The treatment effect τ_{c} measures the effects, based on the differences in potential outcomes, on the user c due to the treatment (e.g., τ_{c} is a causal effect). From the unit level treatment effect τ_{c}, different sample and/or population level parameters can be calculated.

In some embodiments, Sample Average Treatment Effect (SATE), calculated as

$$SATE = \frac{1}{N} {\sum }_{i = 1}^{N} ( {Y}_{i} ( 1 ) - {Y}_{i} ( 0 ) )$$

users, from index i to N, where the N different users include users that are from the treatment group and users that are from the control group (e.g., the difference in potential outcome had all N users been in the treatment group versus the potential outcome had all N users been in the control group). In some embodiments, Sample Average Treatment Effect on Treated (SATT), calculated as

$$SATT = \frac{1}{N} {\sum }_{i = 1}^{N} ( {Y}_{i} ( 1 ) - {Y}_{i} ( 0 ) \vert {T}_{i} = 1 )$$

provides an average of the unit level treatment effect τᵢ for N different users, from index i to N, where the N different users include only users that are from the treatment group (e.g., the difference in potential outcome among the users in the treatment group who were presented with K number of content items versus the potential outcome they would have had if they had been in the control group and were presented with non-K number of content items). In some embodiments, Sample Average Treatment Effect on Control (SATC), calculated as

$$SATC = \frac{1}{N} {\sum }_{i = 1}^{N} ( {Y}_{i} ( 1 ) - {Y}_{i} ( 0 ) \vert {T}_{i} = 0 )$$

provides an average of the unit level treatment effect τᵢ for N different users, from index i to N, where the N different users include only users that are from the control group (e.g., the difference in potential outcome among the users in the control group who were presented with non-K number of content items versus the potential outcome they would have had if they had been in the treatment group and were presented with K number of content items).

In some embodiments, the Average Treatment Effect (ATE) and the Average Treatment Effect on Treated (ATT) may differ due to heterogeneous treatment effects, when the treatment effects (e.g., τᵢ) is not constant across the users in the network environment. For example, presenting K number of content items may increase user interaction for some users but not other users (e.g., where K is a larger number of content items, user interaction for users who have a higher likelihood to spend more time on the network environment may increase but may not for users who do not spend much time on the network environment).

In some embodiments, a post-hoc selection of a subset of users may provide a Conditional Treatment Effect (CTE), calculated as

$$C T E = {\sum }_{i = 1}^{N} ( {Y}_{i} ( 1 ) - {Y}_{i} ( 0 ) \vert Condition ) .$$

For example, the condition may correspond to the subset of users that spends more than a threshold amount of time on the network environment (e.g., based on data stored in the data storage system 202), and CTE calculates the causal difference in user interaction between presenting K number of content items to users who spend more than a threshold amount of time on the network environment versus presenting a non-K number of content items to the users who spend more than the threshold amount of time on the network environment. In some embodiments, one or more calculated parameters of CTE, SATT, SATC, and/or SATE for an iteration i (e.g., corresponding to a particular value of K for a characteristic of the content items) are provided to a reinforcement recspot optimizer (e.g., RRO 310 in FIG. 3). In some embodiments, the treatment effects may be calculated based on one or more of the above-described measures (e.g., CTE, SATT, SATC, and/or SATE). In some embodiments, the treatment effect may be a difference in one or more measures such as, incremental user engagement including click-through-rate, add-to-cart-rate, time spent on a carousel that displays the content items, such as recommended content items, a gross merchandise value and/or a different metric) between a group or subgroup of users under treatment (e.g., receiving K number of content items, viewing K display size of content items, and/or a different characteristic) and the corresponding counterfactuals for the users under treatment. In some embodiments, counterfactuals for the users under treatment may be obtained via using machine learning models as described in further detail below.

In some embodiments, for every user i in the treatment population, a counterfactual is found for the user i by identifying a user j in the control population (e.g., users are not subjected to the treatment) that matches the user i as much as possible (e.g., other covariates or user characteristics of the user j match the covariates of the user i). In some embodiments, the counterfactuals may be found by stratification of users, for example sorting data associated with the users into different layers or groups (e.g., based on geographical location of the users, age group, spending ranges, and/or other characteristics), and identifying a user j in the control population that is in the same layer or group as the user i in the treatment population.

In some embodiments, the counterfactuals may be found by learning embeddings, using a neural network, of the user i in the treatment group and embeddings of users in the control group, to match the user i in the treatment population with the user j in the control population based on the learned embeddings. In some embodiments, the counterfactuals may be found by learning a function that matches users based on propensity scores, or conditional probability of treatment.

In some embodiments, propensity score e(X) may be the conditional probability of treatment (e.g., T=1) given a covariate X (e.g., an observed feature vector X): e(X)=Pr(T=1|X). For example, a propensity score may capture the likelihood of a user taking an action such as clicking on a content item or adding an item (e.g., associated with a content item) to a cart. In some embodiments, matching propensity scores of the user i in the treatment population and the user j in the control population may include balancing the following conditional probabilities:

$$P r ( X \vert T = 1 , e ( X ) ) = P r ( X \vert T = 0 , e ( X ) ) ↔ T ⊥ X \vert e ( X )$$

such that treatment T is independent of covariate X (e.g., a feature vector X that captures causal features, such as all causal features) given the propensity score e(X). In some embodiments, for the user i in the treatment population and the user j in the control population, if e(Xᵢ)=e(Xⱼ) then the covariate Xᵢ (e.g. feature vector Xᵢ of the user i in the treatment population) may not have to be matched with Xⱼ (e.g. feature vector Xⱼ of the user j in the control population), instead they may be matched based on propensity scores alone. For example, prior to matching of propensity scores, the user i in the treatment population may have a different density function distribution from the user j in the control population, and the two density function distributions may become much closer after matching of the propensity scores, thereby restoring the A/B test equivalence. In some embodiments, differences in outcome (e.g., time, or amount spent) between the control group and the treatment group after their propensity scores have been matched may provide the causal estimates (e.g., due to the treatment provided to the treatment group). In some embodiments, propensity scores may be estimated using generalized linear models.

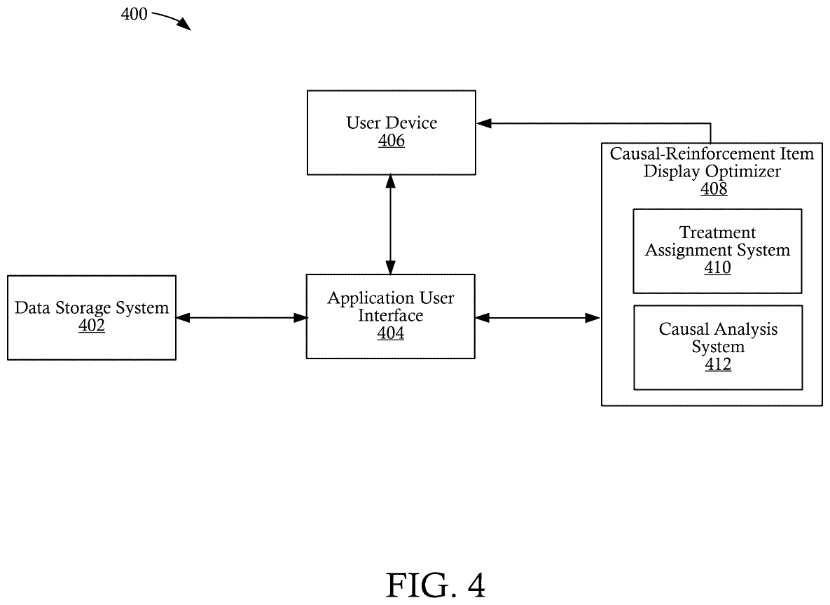

FIG. 4 is a block diagram of an example item display selection system within a network environment in accordance with some embodiments. The item display selector 400 may be implemented by a computing device, such as the item display selection computing device 102 illustrated in FIG. 1. In some embodiments, the item display selector 400 selects a recommended value for one or more characteristics of content items that are presented to a user via an application user interface 404 (e.g., generated by an interface generator analogous to the interface generator 140 in FIG. 1, or by an interface generator communicatively coupled to the item display optimizer 300) on a user device 406. In some embodiments, the item display selector 400 includes a causal-reinforcement item display optimizer 408 having a causal analysis system 412, analogous to the causal recspot lift estimator (CRLE) 308, and a treatment assignment system 410 that may include the reinforced recspot optimizer (RRO) 310. User feedback from user interaction with the application user interface 404 may be provided to the causal-reinforcement item display optimizer 408 to refine the recommendation value generated by the causal-reinforcement item display optimizer 408, and may then be provided to the user device 406 (e.g., for displaying to the user, via the application user interface 404, content items having a characteristic that matches the recommended value). The item display selector 400 also includes or is communicatively coupled to a data storage system 402, analogous to the data storage system 202. The data storage system 402 may provide relevant information from various databases (e.g., item information, recommendation information and/or other information described with reference to the data storage system 202) to the application user interface 404.

FIG. 5 is a schematic diagram of an example causal inference framework 500 in accordance with some embodiments. The framework 500 identifies treatment users 502 of the network environment, sometimes referred to as treatment users, who are provided with content items having a characteristics of a first value. The framework 500 identifies control users 504 of the network environment, sometimes referred to as control users, who are provided with content items having a second value, different from the first value, with respect to the characteristics. For example, the characteristics may relate to a quantity of content items that is presented to users. The treatment users 502 are presented with a first number of content items while the control users 504 are presented with a second number of content items, different from the first number of content items. In addition, or alternatively, the characteristics may relate to display sizes of content items that are presented to users. The treatment users 502 may be presented with a first display size of content items while the control users 504 are presented with a second display size of content items, either larger or smaller than the first display size. In some embodiments, the number of control users is much larger than the number of treatment users (e.g., hundreds or thousands of treatment users, compared to millions of control users).

User features of the treatment users 502 and at least a subset of the control users 504 are provided to a propensity model 506, which computes a propensity score for each of the treatment users and at least the subset of control users. In some embodiments, each treatment user 502 may be matched to a respective control user 504 having the closest propensity score to the treatment user. In some embodiments, after a respective treatment user 502 is matched to a control user 504, a causal model 508 is used to calculate a predicted outcome 510 for the treatment user 502 and to calculate a predicted outcome 512 for the control user 504. In some embodiments, the causal model 508 includes two models M_{C} and M_{T} that are used to predict outcomes for the control group and the treatment group, respectively. For example, for any a particular user u, M_{T}(u)−M_{C}(u) may provide user-level causal estimates regarding the effect of the treatment, while an expectation value for M_{T}(u)−M_{C}(u) may provide population averages. In some embodiments, a causal effect calculator 514 computes a difference between the predicted outcome 510 and the predicted outcome 512 to determine a causal effect (e.g., a treatment effect, an impact, a lift, and/or an incrementality). For example, for each user u (e.g., also called experimentation or observation unit), the causal effect or causal estimate may be the difference between the outcomes predicted by M_{T} and M_{C} with u as an input vector.

In some embodiments, the propensity model 506 calculates propensity scores by fitting a binary regression (e.g., a logistic regression or a statistical machine learning model that predicts the probability) on the group of control users 504 and on the group of treatment users 502, by using a target 0 for control and a target 1 for treatment group of observation units. The propensity model 506 may perform propensity matching explicitly or through binning of the propensity scores from different ranges. In some embodiments, for each bin of the propensity score, the causal model 508 builds a model M_{c} for the control users and a model Mt for treatment users to predict their respective potential outcomes Y (e.g., a predicted outcome 510 for the treatment group, and/or a predicted outcome 512 for the control users), which may be between 0 and 1. In some embodiments, the use of two separate models M_{c} and Mₜ may enable the general treatment effect to be calculated.

In some embodiments, a reinforced recspot optimizer (e.g., RRO 310) may dynamically select a value K for the at least one characteristic of the content items based on the expected increases (e.g., determined based on one or more of the treatment effects, ATE, ATT and/or the ATC) calculated by the CRLE 308. For example, the recommended value for the at least one characteristic of the plurality of content items is calculated using the RRO 310 and based on the expected increase in user interaction with the plurality of content items. In some embodiments, the dynamically selected value K facilitates user interaction (e.g., improves and/or maximizes long term user interaction or user engagement). In some embodiments, reinforcement learning incorporates feedback from the users regarding a current state of the model to improve and/or update the model for subsequent prediction.

In some embodiments RRO 310 includes a state representor that stores information about state representation. In some embodiments, the state sₜ at time t may include (1) a representation of user features and/or (2) values associated with an expected increase in user interactions. In some embodiments, the user features include features associated with one of more user behavior (e.g., usage history on the network environment, transaction data stored in the data storage system 202), user preference, and user demographics (e.g., demographic data stored in the data storage system 202). In some embodiments, the values associated with an expected increase in user interactions include lift values. For example, for each possible value of K (e.g., of a characteristic of the content items), a lift value Lₖ representing an expected increase in user interaction and/or user engagement may be calculated by the CRLE 308. In some embodiments RRO 310 includes or is communicatively coupled to a database that stores an action space A containing all possible values of K of a characteristic of the content items (e.g., a quantity of content items that are presented and/or recommended to a user, recspots) that can be recommended to a user. For example, the action space A={1, 2, 3, . . . , Kₘₐₓ}, where Kₘₐₓ is the maximum value for the characteristic of the content items (e.g., the maximum number of recspots available). At each time step, a reinforcement learning (RL) agent of the RRO 310 may select an action at from the action space A (e.g., aₜ∈A), where the action at corresponds to recommending and/or presenting K (e.g., a value between 1 to Kₘₐₓ within the action space) content items to the user.

In some embodiments RRO 310 includes a reward function calculator that computes a reward function rt for each iteration i to determine how each value of K (e.g., recspot) impacts user interaction and/or user engagement based on one or more parameters for a respective iteration i calculated by the CRLE 308 (e.g., the average treatment effect ATEᵢ for that respective iteration i). In some embodiments, the RRO 310 includes a policy trainer. For example, a policy π(aₜ|sₜ) may define, given the state information, e.g., provided by representation sₜ, what action at (e.g., within the action space A) is to be taken. In some embodiments, an objective of the reinforcement learning agent in the RRO 310 is to learn a policy (e.g., an improved policy, an optimal policy) that increases (e.g., maximizes) an expected cumulative reward Q* over time:

$${Q}^{*} ( s , a ) = {max}_{π} 𝔼 [ {\sum }_{t = 0}^{∞} {γ}^{t} {r}_{t} \vert {s}_{0} = s , {a}_{0} = a , π ] \qquad ( 1 )$$

where γ is a discount factor (e.g., between 0-1, and/or slightly less than 1, such as 0.99, or another value) that weighs the reward function rₜ, and due to γ being raised to the power of t, reward functions rₜ that are more recent (e.g., t closer to 0) are given higher weight, and the more distant past or future (e.g., larger t) may be given a lower weight. For example, such a discounting approach may prioritize more current or immediate rewards over future rewards. The reward function is calculated for a policy It that maps an action do to be taken (e.g., number K of content items to be displayed, a display size of content items to be displayed) based on a state so of a user. In some embodiments the policy may be updated based on the following:

$$Q ( {s}_{t} , {a}_{t} ) ← Q ( {s}_{t} , {a}_{t} ) + α [ {r}_{t} + γ {max}_{{a}^{′}} Q ( {s}_{t + 1} , {a}^{l} ) - Q ( {s}_{t} , {a}_{t} ) ] \qquad ( 2 )$$

where α is the learning rate, and sₜ₊₁ is the state at a subsequent time point, and a′ corresponds to an action mapped by the policy for the state sₜ₊₁.

FIG. 6 is a schematic diagram of an example reinforcement learning optimizer 600 in accordance with some embodiments. In some embodiments a causal recspot lift estimator CRLE 606, analogous to the CRLE 308, provides state information sₜ, which may include the expected increase associated with a respective K, to a reinforced recspot optimizer policy 608. The state information St may be optionally calculated based on user interactions with an application user interface 604 when content items having a characteristic corresponding to the value of K are presented to a user. In some embodiments, the RRO policy 608 uses a stored policy (e.g., a current policy, and/or a policy updated based on a most recent update) to determine an action Aₜ to be taken (e.g., that provides an expected increase in user interaction), based on the station information Sₜ. Information about action Aₜ is provided to the application user interface 604 to generate content items having the characteristic corresponding to a recommended value associated with the action Aₜ. For example, the action Aₜ may be associated with displaying a recommended number K of content items to the user, and/or displaying a recommended size of content items to the user.

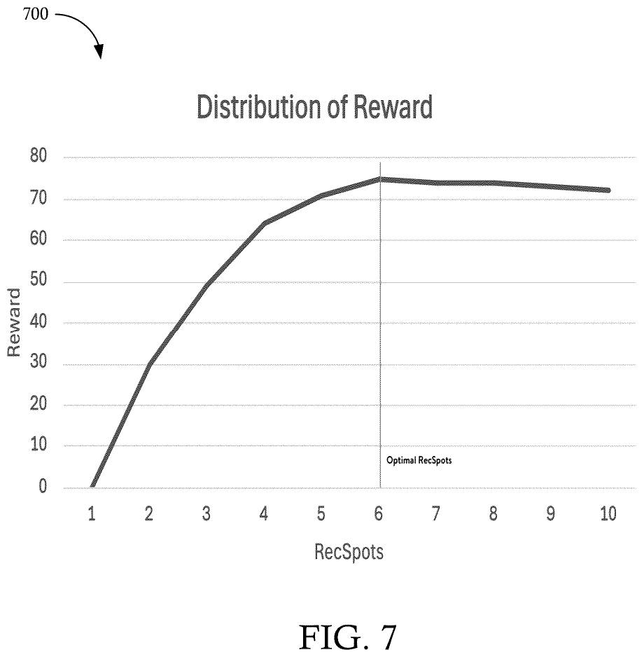

In some embodiments, a reward function rₜ may be calculated, based on user interactions at the application user interface 604, and the reward function rₜ is provided to an RRO model updater 610. In some embodiments, the RRO model updater 610 may update a policy It that maps an action (e.g., a₀) to be taken (e.g., number K of content items to be displayed, a display size of content items to be displayed) based on state information (e.g., s₀) about a user, and a learning rate α, as described above with reference to Equation 2, and provide the updated policy to be stored as the current RRO policy 608. In some embodiments, for each value of K, the RRO model policy 608 is updated with a corresponding lift (e.g., reward function) and with an incremental change in lift. FIG. 7 is an example distribution 700 of a reward function in accordance with some embodiments. In some embodiments, the distribution 700 reflects a rate of increase of lift diminishing with increasing values of K. In some embodiments, rates of change for the reward function rₜ may be taken into account and incorporated into the RRO model policy 608 to reduce the search space for updating and/or optimizing the policy π to regions around an inflection point of the distribution 700.

In some embodiments, the item display selection computing device 102 may enhance personalization by being responsive to and/or catering to user or user group preferences and/or the user's browsing behavior. In some embodiments, the item display selection computing device 102 may provide a more accurate measurement by providing a more precise analysis of the causal impact of varying a number of content items that are displayed to user in a recommendation carousel and/or a display size of content items in the recommendation carousel, and may enable for more data-driven optimization that permits informed decisions to be made based on reliable causal insights. In some embodiments, content placement may be enhanced (e.g., sponsored content placement can be optimized) by placing specific content items (e.g., sponsored content items) in positions that increases (e.g., maximizes) visibility and engagement. In some embodiments, the recommended content items are selected based on context (e.g., if a user has selected a first item, a second complementary item may be displayed, such a pairing of jeans, selected as the first item, and a polo shirt, displayed as the second complementary item). In some embodiments, the methods and systems described herein may be used to provide performance-based placement of content item (e.g., banner). For example, the content item may be placed in a top, middle, or bottom portion of a user interface, within a hierarchy of a recommended number of content items (e.g., 3, 4, or 5 content items) by selecting, or optimizing a value for a characteristic of the content item that would result in a highest likelihood of user engagement. In some embodiments, the recommended value for a characteristic of the content items is a value that increases a likelihood for user interaction at a group or cohort level (e.g., for a group of users, for users in a treatment group, and/or personalized for a group of users at the group level). In some embodiments, the recommended value for a characteristic of the content items is a value that increases a likelihood for user interaction at an individual level (e.g., personalized for user in the treatment group at the individual level). For example, the item display selection computing device 102 may select fifteen content items to be displayed to new users of the network environment and ten content items to returning users based on user engagement and/or user interaction data.

In some embodiments, the item display selection computing device 102 may be able to customize the design and/or placement of content items in the application user interface to have a number of content items (e.g., an optimal number of content items) that result in increased user interaction. In some embodiments, the content items are displayed in bundled fashion, in which a slot for a single content item is sub-divided to display two content items (e.g., two contextually related items, such as jeans and a polo shirt). In some embodiments, different user interfaces may be generated based on the causal estimate (e.g., generated by the reinforcement learning optimizer 600, the CRLE 308, and/or item display selection computing device 102) to display content items based on design and/or space availability. For example, similar content items may be shown in different ways (e.g., staggered, overlapping, thumbnails and/or other designs or arrangements). In some embodiments, an increase in user interactions (e.g., an improvement of, for example, 10% in user engagement) may result in a sizable increase in transaction volume and/or monetary amount (e.g., millions) on the network environment.

In some embodiments, the methods and systems described herein provide an end-to-end (e.g., from data ingestion processes that extract transaction features, recommendation features, demographic features, and interaction features to a ranked list of content items having a characteristic of a recommended value) automated architecture that provides a ranked listing of relevant content items associated with different items listed in the network environment, that is also scalable for up to millions of users of the network environment.

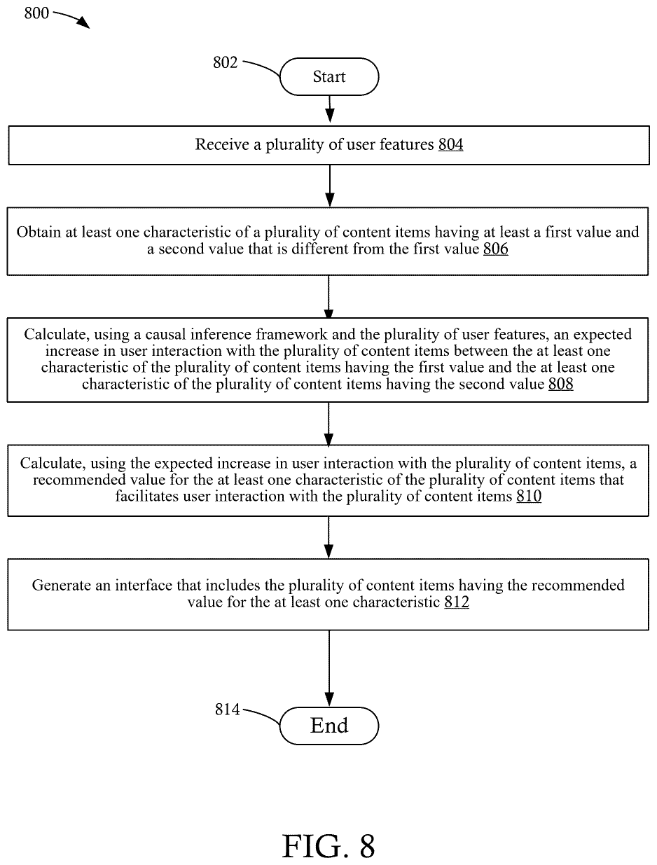

FIG. 8 is a flow diagram depicting an example method. In some embodiments, one or more blocks of the method may be executed substantially concurrently and/or in a different order than shown. In some implementations, a method may include more or fewer blocks than are shown. In some implementations, one or more of the blocks of a method may, at certain times, be ongoing and/or repeat. In some implementations, blocks of the method may be combined.

The method shown in FIG. 8 may be implemented in the form of executable instructions stored on machine-readable media and executed by a processing resource and/or in the form of electronic circuitry. For example, aspects of the methods may be described below as being performed by a content item selection system, an example of which may be the content item selection process 800 running on a hardware processing resource 104 of the item display selection computing device 102 described above. Additionally, other aspects of the methods described below may be described with reference to other elements shown in FIG. 1 for non-limiting illustration purposes.

FIG. 8 depicts a flow diagram illustrating a method 800 of content item selection, or item display selection, in accordance with some embodiments. Method 800 starts at block 802 and continues to block 804, where a plurality of user features may be received. At block 806, at least one characteristic of a plurality of content items having at least a first value and a second value that is different from the first value. For example, the least one characteristics may relate to a quantity of content items that is presented to users, the first value may be five content items or another number, and the second value may be three content items or another number different from the first value. The at least one characteristic may be display sizes of content items that are presented to users, the first value may be 256 pixels in width and/or length of the content item, or another number of pixels, and the second value may be 128 pixels in width and/or length of the content item, or another number of pixels or another number different from the first value.

At block 808, an expected increase in user interaction with the plurality of content items between the at least one characteristic of the plurality of content items having the first value and the at least one characteristic of the plurality of content items having the second value may be calculated. For example, when presented with a first value of five content items, a user may spend three minutes interacting (e.g., viewing, clicking, and/or other interactions) with one or more of the five content items. In contrast, when presented with a second value of three content items, a user may spend one minute interacting with one or more of the three content items. The expected increase in user interaction, calculated by the causal interference framework, is based on the change in interaction (e.g., from one minute to three minutes) caused by the change between the first value and the second value of the at least one characteristic of the content items presented to the users.

At block 810, using the expected increase in user interaction with the plurality of content items, a recommended value for the at least one characteristic of the plurality of content items that facilitates user interaction with the plurality of content items may be calculated. For example, facilitating user interface with the plurality of content items may include selecting a number of content items that is presented to the one or more users that increases long term user engagement with the plurality of content items, such as maximizing long term user engagement. In some embodiments, the recommended value may be calculated using a reinforcement learning optimizer, as described in further detail with reference to FIG. 6.

At block 812, an interface including the plurality of content items having the recommended value for the at least one characteristic may be generated. For example, an interface having five content items is generated and displayed to one or more users. At block 814, the method 800 ends.

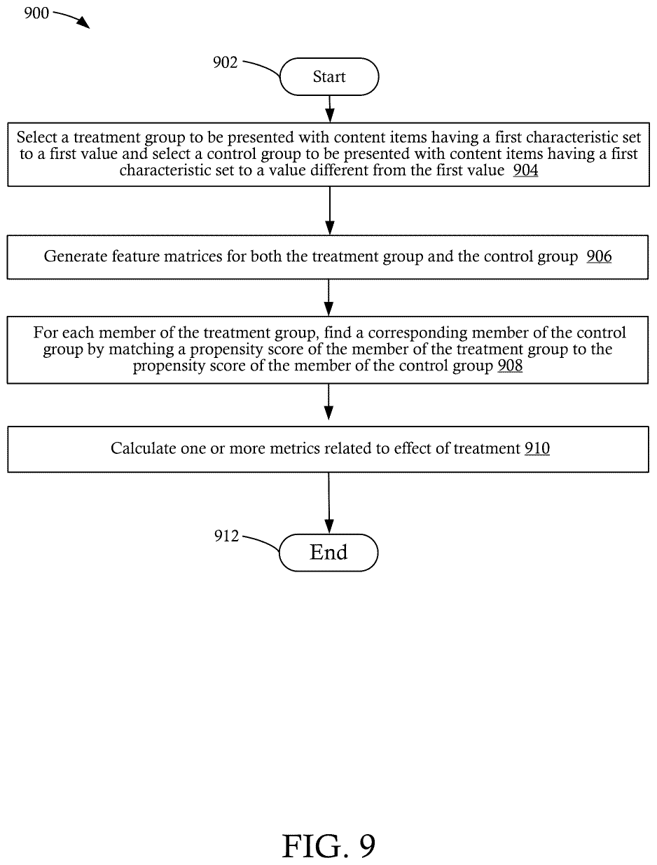

FIG. 9 depicts a flow diagram illustrating an example causal inference method in accordance with some embodiments. Method 900 starts at block 902 and continues to block 904, where a treatment group to be presented with content items having a first characteristic set to a first value is selected and a control group to be presented with content items having a first characteristic set to a value different from the first value is selected. At block 906, feature matrices for both the treatment group and the control group are generated. At block 908, for each member of the treatment group, a corresponding member of the control group by matching a propensity score of the member of the treatment group to the propensity score of the member of the control group is found. At block 910, one or more metrics related to effect of treatment is calculated. At block 912, the method 900 ends.

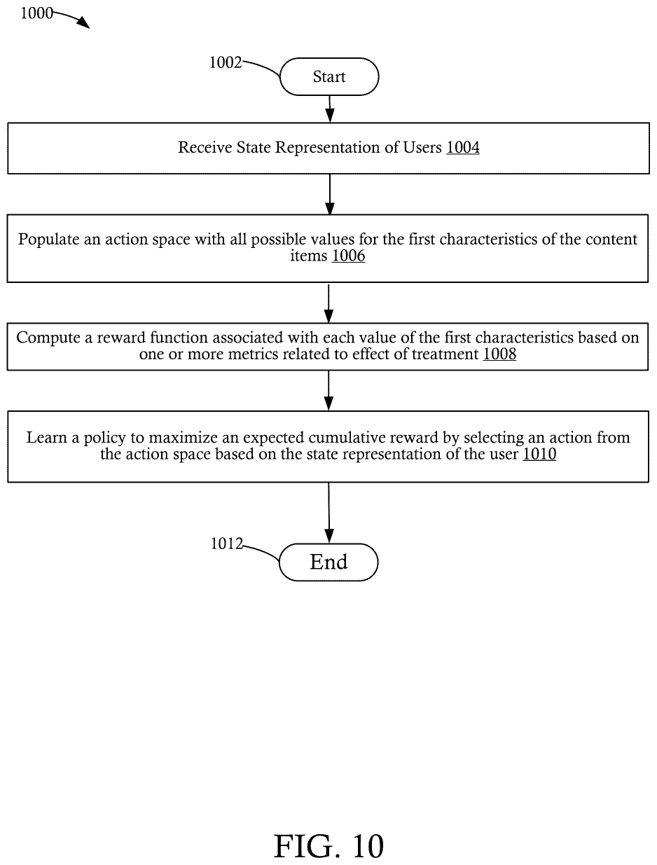

FIG. 10 depicts a flow diagram illustrating an example reinforcement learning optimization method in accordance with some embodiments. Method 1000 starts at block 1002 and continues to block 1004, where state representations of one or more users are received (e.g., state representation sₜ described with reference to FIG. 6). At block 1006, an action space with all possible values for the first characteristics of the content items is populated (e.g., action space A described with reference to FIG. 6). At block 1008, a reward function associated with each value of the first characteristics based on one or more metrics related to effect of treatment an expected increase in user interaction with the plurality of content items between the at least one characteristic of the plurality of content items having the first value and the at least one characteristic of the plurality of content items having the second value may be computed (e.g., the reward function r(t) described with reference to FIG. 6). At block 1010, a policy to maximize an expected cumulative reward by selecting an action from the action space based on the state representation of the user may be learned. At block 1012, the method 1000 ends.

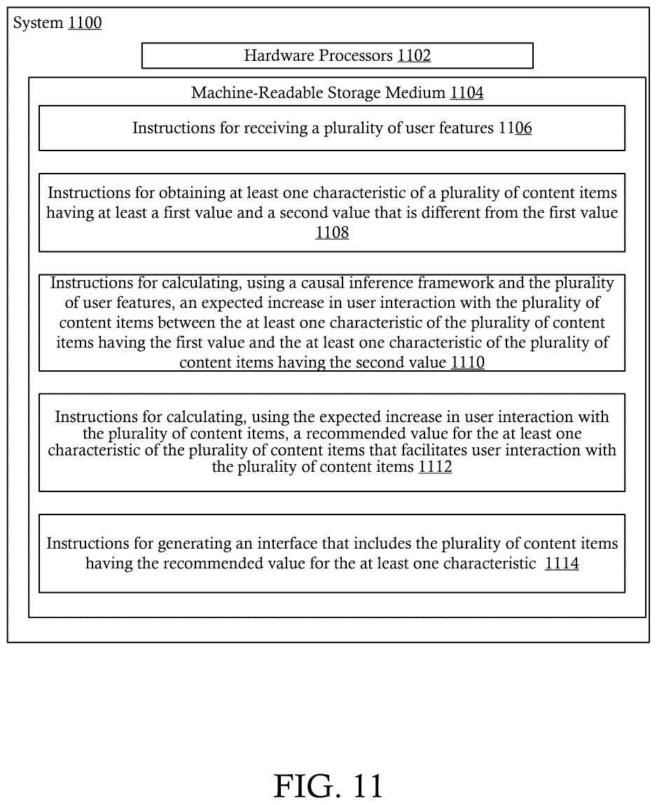

FIG. 11 depicts an example system 1100 that includes non-transitory, machine-readable media 1104 encoded with example instructions executable by processing resource 1102. In some implementations, the system 1100 may be useful for implementing aspects of the item display selector 130 of FIG. 1. For example, the instructions encoded on machine-readable media 1104 may be included in instructions 108 of FIG. 1. In some implementations, functionality described with respect to FIG. 1 may be included in the instructions encoded on machine-readable media 1104.

The processing resource 1102 may include a microcontroller, a microprocessor, central processing unit core(s), an ASIC, an FPGA, and/or other hardware device suitable for retrieval and/or execution of instructions from the machine-readable media 1104 to perform functions related to various examples. Additionally, or alternatively, the processing resource 1102 may include or be coupled to electronic circuitry or dedicated logic for performing some or all of the functionality of the instructions described herein.

The machine-readable media 1104 may be any medium suitable for storing executable instructions, such as RAM, ROM, EEPROM, flash memory, a hard disk drive, an optical disc, or the like. In some example implementations, the machine-readable media 1104 may be a tangible, non-transitory medium. The machine-readable media 1104 may be disposed within the computing device 1200 respectively, in which case the executable instructions may be deemed installed or embedded on the system. Alternatively, the machine-readable media 1104 may be a portable (e.g., external) storage medium and may be part of an installation package.

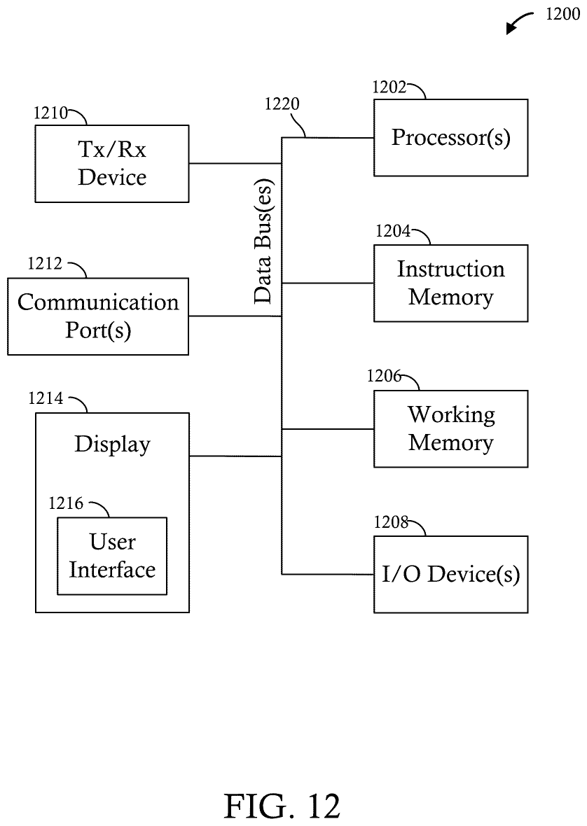

As described further herein below, the machine-readable media 1104 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 12.

With reference to FIG. 11, the machine-readable media 1104 includes instructions 1106-1112. Instructions 1106, when executed, cause the processing resource 1102 to receive a plurality of user features. Instructions 1108, when executed, cause the processing resource 1102 to obtain at least one characteristic of a plurality of content items having at least a first value and a second value that is different from the first value.

In accordance with a determination that the similarity score is greater than the first threshold, instructions 1110, when executed, cause the processing resource 1102 to calculate, using a causal inference framework and the plurality of user features, an expected increase in user interaction with the plurality of content items between the at least one characteristic of the plurality of content items having the first value and the at least one characteristic of the plurality of content items having the second value.

Instructions 1112, when executed, cause the processing resource 1102 to calculate, using the expected increase in user interaction with the plurality of content items, a recommended value for the at least one characteristic of the plurality of content items that facilitates user interaction with the plurality of content items (e.g., using a reinforcement learning based optimizer, such as the reinforced learning optimizer 212, and/or the RRO 310). In some embodiments, user interactions provide reward signals that may be used to update a policy and/or value function of a reinforcement learning optimizer. For example, the expected increase in user interaction (e.g., add to carts or increase in transactions or orders) may be a metric for policy evaluation.

Instructions 1114, when executed, cause the processing resource 1102 to generate an interface that includes the plurality of content items having the recommended value for the at least one characteristic. In some embodiments, for new users or content items with insufficient historical data, the methods and systems described herein may utilize a default or generalized model based on data from similar users or content items until sufficient data is collected to personalize the recommendations.

FIG. 12 illustrates a block diagram of a computing device 1200, in accordance with some embodiments. Although FIG. 12 is described with respect to certain components shown therein, it will be appreciated that the elements of the computing device 1200 may be combined, omitted, and/or replicated. In addition, it will be appreciated that additional elements other than those illustrated in FIG. 12 may be added to the computing device.

As shown in FIG. 12, the computing device 1200 may include one or more processing resources 1202, instruction memory 1204, working memory 1206, one or more input/output devices 1208, transceiver 1210, communication ports 1212, display 1214, and/or any other suitable elements each operatively coupled to one or more data buses 1220. The data buses 1220 enable communication among the various components. The data buses 1220 may include wired, or wireless, communication channels.

The one or more processing resources 1202 may include any processing circuitry operable to control operations of the computing device 1200. In some embodiments, the one or more processing resources 1202 include one or more distinct processors, each having one or more cores (e.g., processing circuits). Each of the distinct processors may have the same or different structure. The one or more processing resources 1202 may include one or more central processing units (CPUs), one or more graphics processing units (GPUs), ASICs, digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 1202 may also be implemented by a controller, a microcontroller, an ASIC, an FPGA, a programmable logic device (PLD), etc.

In some embodiments, the one or more processing resources 1202 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 1204 may store instructions that are accessed (e.g., read) and executed by at least one of the one or more processing resources 1202. For example, the instruction memory 1204 may be a non-transitory, computer-readable storage medium such as a ROM, an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 1202 may perform a certain function or operation by executing code, stored on the instruction memory 1204, embodying the function or operation. For example, one or more processing resources 1202 may execute code stored in the instruction memory 1204 to perform one or more of any function, method, or operation disclosed herein.

Additionally, the one or more processing resources 1202 may store data to, and read data from, the working memory 1206. For example, one or more processing resources 1202 may store a working set of instructions to the working memory 1206, such as instructions loaded from the instruction memory 1204. The one or more processing resources 1202 may also use the working memory 1206 to store dynamic data created during one or more operations. The working memory 1206 may include, for example, RAM such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), CAM, polymer memory (e.g., ferroelectric polymer memory), phase-change memory (e.g., ovonic memory), ferroelectric memory, SONOS memory, a removable disk, CD-ROM, any non-volatile memory, or any other suitable memory. Although embodiments are illustrated herein including separate instruction memory 1204 and working memory 1206, it will be appreciated that the computing device 1200 may include a single memory unit that operates as both instruction memory and working memory. Further, although embodiments are discussed herein including non-volatile memory, it will be appreciated that computing device 1200 may include volatile memory components in addition to at least one non-volatile memory component.

In some embodiments, the instruction memory 1204 and/or the working memory 1206 includes an instruction set, in the form of a file for executing various methods, such as methods for generating an interface based on location data and resource use probability, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter converts the instruction set into machine executable code for execution by the one or more processing resources 1202.

The input/output devices 1208 may include any suitable device that enables data input or output. For example, the input/output devices 1208 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 1210 and/or the communication port(s) 1212 enable communication with a network. For example, if a communication network is a cellular network, the transceiver 1210 enables communications with the cellular network. In some embodiments, the transceiver 1210 is selected based on the type of the communication network the computing device 1200 will be operating in. The one or more processing resources 1202 are operable to receive data from, or send data to, a network, via the transceiver 1210.

The communication port(s) 1212 may include any suitable hardware, software, and/or combination of hardware and software that is capable of coupling the computing device 1200 to one or more networks and/or additional devices. The communication port(s) 1212 may be arranged to operate with any suitable technique for controlling information signals using a desired set of communications protocols, services, or operating procedures. The communication port(s) 1212 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 1212 enables the programming of executable instructions in instruction memory 1204. In some embodiments, the communication port(s) 1212 enable(s) the transfer (e.g., uploading or downloading) of data, such as machine learning model training data.

In some embodiments, the communication port(s) 1212 couples the computing device 1200 to a network. The network may include local area networks (LAN) as well as wide area networks (WAN) including without limitation internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 1210 and/or the communication port(s) 1212 utilize one or more communication protocols. Examples of wired protocols may include, but are not limited to, USB communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 902.xx series of protocols, such as IEEE 902.11a/b/g/n/ac/ag/ax/be, IEEE 902.16, IEEE 902.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 1214 may be any suitable display and may display the user interface 1216. The user interface 1216 may enable user interaction with interface elements representative of the item display selector 130. For example, the user interface 1216 may be a user interface for an application of a network environment operator that enables a user to view and interact with the operator's website. In some embodiments, a user may interact with the user interface 1216 by engaging the input/output devices 1208. In some embodiments, the display 1214 may be a touchscreen, where the user interface 1216 is displayed on the touchscreen.

The display 1214 may include a screen such as, for example, a Liquid Crystal Display (LCD) screen, a light-emitting diode (LED) screen, an organic LED (OLED) screen, a movable display, a projection, etc. In some embodiments, the display 1214 may include a coder/decoder, also known as Codecs, to convert digital media data into analog signals. For example, the visual peripheral output device may include video Codecs, audio Codecs, or any other suitable type of Codec.

In some embodiments, the computing device 1200 implements one or more modules or engines, each of which is constructed, programmed, configured, or otherwise adapted, to autonomously carry out a function or set of functions. A module/engine may include a component or arrangement of components implemented using hardware, such as by an ASIC or FPGA, for example, or as a combination of hardware and software, such as by a microprocessor system and a set of program instructions that adapt the module/engine to implement the particular functionality that (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices) that execute an operating system, system programs, and application programs, while also implementing the engine using multitasking, multithreading, distributed (e.g., cluster, peer-peer, cloud) processing where appropriate, or other such techniques. Accordingly, each module/engine may be realized in a variety of physically realizable configurations and should generally not be limited to any particular example implementation herein, unless such limitations are expressly called out. In addition, a module/engine may itself be composed of more than one sub-module or sub-engine, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

In some embodiments, the computing device 1200 may be a computer, a workstation, a laptop, a server such as a cloud-based server, or any other suitable device. In some embodiments, the computing device 1200 is a server that includes one or more processing units, such as one or more GPUs, one or more CPUs, and/or one or more processing cores. The computing device 1200 may, in some embodiments, execute one or more virtual machines. In some embodiments, processing resources (e.g., capabilities) of the computing device 1200 are offered as a cloud-based service (e.g., cloud computing).

Although embodiments are illustrated herein including certain systems and/or devices, it will be appreciated that additional systems, servers, storage mechanisms, etc. may be included. In addition, although embodiments are illustrated herein having individual, discrete systems, it will be appreciated that, in some embodiments, one or more systems may be combined into a single logical and/or physical system. Similarly, although embodiments are illustrated having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

Although the subject matter has been described in terms of example embodiments, it is not limited thereto. Rather, the appended claims should be construed broadly, to include other variants and embodiments that may be made by those skilled in the art.

What is claimed is:

1. A system, comprising:
a processor; and
a non-transitory memory storing instructions, that when executed, cause the processor to:
receive a plurality of user features;
obtain at least one characteristic of a plurality of content items having at least a first value and a second value that is different from the first value;
calculate, using a causal inference framework and based on the plurality of user features, an expected increase in user interaction with the plurality of content items between the at least one characteristic of the plurality of content items having the first value and the at least one characteristic of the plurality of content items having the second value;
calculate, using the expected increase in user interaction with the plurality of content items, a recommended value for the at least one characteristic of the plurality of content items that facilitates user interaction with the plurality of content items; and
generate an interface that includes the plurality of content items having the recommended value for the at least one characteristic.

2. The system of claim 1, wherein the at least one characteristic of the plurality of content items comprises a quantity of the plurality of content items, or a display size of the plurality of content items.

3. The system of claim 1, wherein the plurality of user features includes one or more of: transactional features, features associated with user interaction with the plurality of content items, or demographic features.

4. The system of claim 1, wherein the causal inference framework comprises a counterfactual estimator.

5. The system of claim 4, wherein the counterfactual estimator calculates the expected increase in user interaction by matching (i) a selected user presented with the plurality of content items having the at least one characteristic of the first value to (ii) a control user presented with the plurality of content items having the at least one characteristic of a value different from the first value based on matching a propensity score of the selected user to a propensity score of the control user.

6. The system of claim 1, wherein the recommended value for the at least one characteristic of the plurality of content items is calculated using a reinforcement learning optimizer and based on the expected increase in user interaction with the plurality of content items.

7. The system of claim 1, wherein the instructions, when executed, further cause the processor to train a ranking model based on user interactions with the plurality of content items to generate a ranked listing of the plurality of content items based on a likelihood of user interaction with the plurality of content items.

8. A computer-implemented method, comprising:
receiving a plurality of characteristics associated with one or more users;
obtaining at least one characteristic of a plurality of content items having at least a first value and a second value that is different from the first value;
calculating, using a causal inference framework and based on the plurality of characteristics associated with the one or more users, an expected increase in user interaction with the plurality of content items between the at least one characteristic of the plurality of content items having the first value and the at least one characteristic of the plurality of content items having the second value;
calculating, using the expected increase in user interaction with the plurality of content items, a recommended value for the at least one characteristic of the plurality of content items that facilitates user interaction with the plurality of content items; and
generating an interface that includes the plurality of content items having the recommended value for the at least one characteristic.

9. The computer-implemented method of claim 8, wherein the at least one characteristic of the plurality of content items comprises a quantity of the plurality of content items, or a display size of the plurality of content items.

10. The computer-implemented method of claim 8, wherein the plurality of characteristics associated with the one or more users includes one or more of: transactional features, features associated with user interaction with the plurality of content items, or demographic features.

11. The computer-implemented method of claim 8, wherein the causal inference framework comprises a counterfactual estimator.

12. The computer-implemented method of claim 11, wherein the counterfactual estimator calculates the expected increase in user interaction with the plurality of content items by matching (i) a selected user presented with the plurality of content items having the at least one characteristic of the first value to (ii) a control user presented with the plurality of content items having the at least one characteristic of a value different from the first value based on matching a propensity score of the selected user to a propensity score of the control user.

13. The computer-implemented method of claim 8, wherein the recommended value for the at least one characteristic of the plurality of content items is calculated using a reinforcement learning optimizer and based on the expected increase in user interaction with the plurality of content items.

14. The computer-implemented method of claim 8, further comprising training a ranking model based on user interactions with the plurality of content items to generate a ranked listing of the plurality of content items based on a likelihood of user interaction with the plurality of content items.

15. A non-transitory computer readable medium having instructions stored thereon, wherein the instructions, when executed by at least one processor, cause at least one device to perform operations comprising:
receiving a plurality of characteristics associated with one or more users;
obtaining at least one characteristic of a plurality of content items having at least a first value and a second value that is different from the first value;
calculating, using a causal inference framework based on the plurality of characteristics associated with the one or more users, an expected increase in user interaction with the plurality of content items between the at least one characteristic of the plurality of content items having the first value and the at least one characteristic of the plurality of content items having the second value;
calculating, using the expected increase in user interaction with the plurality of content items, a recommended value for the at least one characteristic of the plurality of content items that facilitates user interaction with the plurality of content items; and
generating an interface that includes the plurality of content items having the recommended value for the at least one characteristic.

16. The non-transitory computer readable medium of claim 15, wherein the at least one characteristic of the plurality of content items comprises a quantity of the plurality of content items, or a display size of the plurality of content items.

17. The non-transitory computer readable medium of claim 15, wherein the plurality of characteristics associated with the one or more users includes one or more of: transactional features, features associated with user interaction with the plurality of content items, or demographic features.

18. The non-transitory computer readable medium of claim 15, wherein the causal inference framework comprises a counterfactual estimator.

19. The non-transitory computer readable medium of claim 18, wherein the counterfactual estimator calculates the expected increase in user interaction with the plurality of content items by matching (i) a selected user presented with the plurality of content items having the at least one characteristic of the first value to (ii) a control user presented with the plurality of content items having the at least one characteristic of a value different from the first value based on matching a propensity score of the selected user to a propensity score of the control user.

20. The non-transitory computer readable medium of claim 15, wherein the recommended value for the at least one characteristic of the plurality of content items is calculated using a reinforcement learning optimizer and based on the expected increase in user interaction with the plurality of content items.
